(19) United States
(12) Patent Application Publication
(10) Pub. No.: US 2014/0067904 A1
(43) Pub. Date: Mar. 6, 2014

(54) SELECTION OF TRANSACTION MANAGERS BASED ON RUNTIME DATA

(71) Applicant: INTERNATIONAL BUSINESS MACHINES CORPORATION, Armonk, NY (US)

(72) Inventors: Timothy D. KACZYNSKI, Poughkeepsie, NY (US); Edward E. MEZARINA, Poughkeepsie, NY (US); Matthew J. SYKES, Poughkeepsie, NY (US)

(73) Assignee: INTERNATIONAL BUSINESS MACHINES CORPORATION, Armonk, NY (US)

(21) Appl. No.: 14/076,308

(22) Filed: Nov. 11, 2013

Related U.S. Application Data
(62) Division of application No. 12/332,020, filed on Dec. 10, 2008.

(51) Int. Cl. H04L 29/08

(52) U.S. Cl. CPC H04L 29/08135
USPC 709/201

(57) ABSTRACT

One or more transaction managers are automatically selected from a plurality of transaction managers for use in processing a transaction. This selection is based on the types of resources used by the transaction and runtime data of the transaction managers able to support one or more of those resource types. The selection of the one or more transaction managers enables less than all of the transaction managers of an application server to be used in transaction commit processing, thereby improving performance.

### CROSS-REFERENCE TO RELATED APPLICATION

This application is a divisional of U.S. application Ser. No. 12/332,020, entitled “Selection of Transaction Managers Based on Runtime Data”, filed Dec. 10, 2008, which published Jun. 10, 2010, as U.S. Patent Publication No. 2010/0146033 A1, and which is hereby incorporated herein by reference in its entirety.

### TECHNICAL FIELD

This invention relates, in general, to distributed transactional processing, and in particular, to facilitating selection of transaction managers for use in transactional processing, including use in commit or rollback processing.

### BACKGROUND OF THE INVENTION

The cost, in both computation and time, of performing a two-phase commit across distributed transactional resources is high. The transactional manager must coordinate across multiple types of resource managers to deliver a consistent outcome, i.e., commit or rollback. Resource managers can communicate with a transaction manager in different ways. For example, a Java Transaction API/Distributed Transaction (JTA/XA) compliant resource manager receives protocol messages using an XAResource implementation provided by the resource manager, while a Resource Recovery Services (RRS) compliant resource manager receives protocol messages through exits which it has registered with RRS, offered by International Business Machines Corporation. Often a JTA/XA resource manager communicates over TCP/IP, while an RRS compliant resource manager uses cross-memory communication within the same physical system.

A product like the WebSphere® Application Server, offered by International Business Machines Corporation, often has to deal with multiple types of resource managers. Optimization is difficult in this case because each type of resource manager operates differently. In practice, a single transaction will not need to make updates to all types of resource managers, however, today the transaction manager must support such a scenario.

### SUMMARY OF THE INVENTION

Having an optimized transaction manager for each resource type or a combination of resource types is desirable. Such a configuration, however, requires the customer to choose the transaction manager(s) to use for each transaction. This puts additional administrative burden on the customer, who now must keep track of this information and update it accordingly, if resources are added, removed, or changed from an application.

Based on the foregoing, a need exists for a capability that facilitates the selection of one or more transaction managers for a particular transaction. In particular, a need exists for a capability that selects transaction managers based on resource type, and optimizes that selection based on, for instance, runtime data. A further need exists for a capability that facilitates selection of the one or more transaction managers automatically, such as by an application server, without manual intervention by an administrator. A need exists for a selection capability that is able to eliminate one or more transaction managers from commit processing.

The shortcomings of the prior art are overcome and additional advantages are provided through the provision of a method of facilitating selection of transaction managers for use in transactional processing. The method includes, for instance, obtaining, by an application server executing on at least one processor of a transactional environment and comprising a plurality of transaction managers, runtime statistics of the plurality of transaction managers of the application server, the runtime statistics of a transaction manager of the plurality of transaction mangers including real-time data relating to transaction commit processing performed by the transaction manager for one or more transactions initiated by one or more applications of the application server, wherein the real-time data relating to transaction commit processing includes an amount of time taken to perform one or more previous commits of the transaction commit processing or an amount of data to transfer as part of the one or more previous commits of the transaction commit processing; and after executing a transaction, initiated by an application of the application server, to a commit point of the transaction's execution, at which point the transaction is to be committed, performing: determining one or more types of resources used by the transaction; and based on the determined one or more types of resources used by the transaction, selecting, by the application server, one or more transaction managers of the plurality of transaction managers of the application server to use in performing commit or roll-back processing for the transaction, wherein the selecting comprises identifying transaction managers of the plurality of transaction managers for consideration for use as the one or more transaction managers to use in performing the commit or roll-back processing, and eliminating at least one transaction manager of the identified transaction managers from consideration for use as one or more transaction managers to use in performing the commit or roll-back processing, the eliminating of a transaction manager of the at least one transaction manager being based, at least in part, on the obtained runtime statistics.

Systems and program products relating to one or more aspects of the present invention are also described and claimed herein. Further, services relating to one or more aspects of the present invention are also described and may be claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one example of a transactional processing environment to incorporate and use one or more aspects of the present invention;

FIG. 2 depicts one embodiment of the logic to assign resource types to transaction managers, in accordance with an aspect of the present invention;

FIG. 3 depicts one embodiment of the logic to select one or more transaction managers to use in processing a particular transaction, in accordance with an aspect of the present invention;

FIG. 4 depicts one embodiment of further details of the logic to select one or more transaction managers based on runtime data, in accordance with an aspect of the present invention;

FIG. 5 depicts one example of a sample histogram for a single application component, in accordance with an aspect of the present invention;

FIG. 6 depicts one example of two applications separated into modules and components with each component having its own histogram, in accordance with an aspect of the present invention; and

FIG. 7 depicts one embodiment of a computer program product incorporating one or more aspects of the present invention.

### DETAILED DESCRIPTION OF THE INVENTION

In accordance with an aspect of the present invention, a capability is provided for facilitating selection of one or more transaction managers to be used in transactional processing, including in commit or rollback processing. The selection of the one or more transaction managers for a particular transaction is based on, for instance, the types of resources used by the transaction, as well as runtime data obtained for the various transaction managers supporting the resource types of the transaction. By selecting transaction managers based on resource type and runtime data, one or more transaction managers may not be needed to complete (e.g., commit or rollback) the transaction, thereby enhancing performance.

In one example, the selection is performed automatically by a component of the transaction processing environment, such as an application server or container of the environment. User or administrator interaction is not needed.

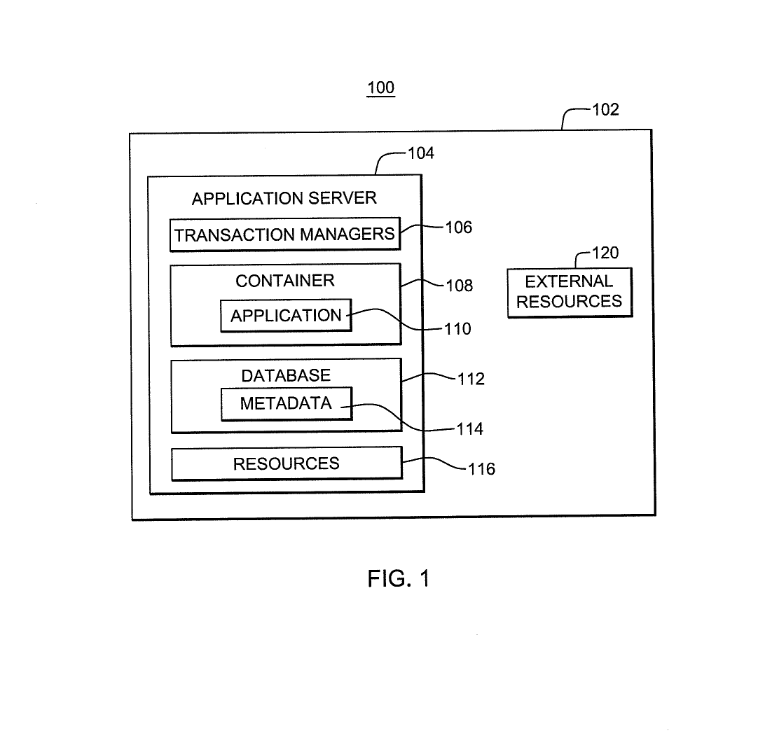

One embodiment of a transactional processing environment to incorporate and use one or more aspects of the present invention is described with reference to FIG. 1. In one example, a transactional processing environment 100 is based on the z/Architecture® offered by International Business Machines Corporation. z/Architecture® is described in, for instance, “z/Architecture—Principles of Operation,” SA22-7832-06, Seventh Edition, February 2008, which is hereby incorporated herein by reference in its entirety. In particular, the transactional processing environment includes at least one z/Series® processor 102, such as a z10 server executing the z/OS® operating system, as an example. The environment can include one server or be distributed across multiple servers. Further, the servers may be other than z10, z/Series® or based on the z/Architecture®. These are only provided as examples. z/Architecture®, z/Series® and z/OS® are registered trademarks of International Business Machines Corporation, Armonk, N.Y. Other names used herein may be registered trademarks, trademarks or product names of International Business Machines Corporation or other companies.

Executing on the at least one processor 102 is, for instance, one or more application servers 104, such as the WebSphere® Application Server offered by International Business Machines Corporation. WebSphere® is based on J2EE, and as one example is described in Program Directory for WebSphere Application Server for z/OS V6.0.1, Publication No. GI11-2825-04, Mar. 25, 2005, which is hereby incorporated herein by reference in its entirety. WebSphere® is a registered trademark of International Business Machines Corporation.

In one example, application server 104 includes a plurality of transaction managers 106, a container 108 that executes at least one application 110, and a database or flat file 112 for saving information including metadata 114. Application 110 initiates one or more transactions to be processed by the transactional environment. In particular, in one example, an application includes one or more modules, and each module includes one or more application components. Each application component can initiate one or more transactions, and each transaction may access one or more resources. In one example, the application defines any resources that it wishes to access in the application's deployment descriptor (e.g., metadata for the application). When the application is deployed onto the application server, the resources defined in the application's deployment descriptor are matched to physical resources, which have been defined to the application server.

As indicated above, application server 104 includes or has access to one or more resources 116, and further may access one or more external resources 120, such as other application servers, databases, etc. In accordance with an aspect of the present invention, each resource 116 and each external resource 120 (or subsets thereof) is assigned a resource type. The resource type describes the transactional protocol used by the resource and is exposed for each resource through metadata such that it can be read by any configuration. For example, a JCA resource exposes this information through an extended deployment descriptor in its RAR file. In the event that such metadata is not available, the resource type is assumed to be unknown. The resource type is saved in database 112, in particular, as metadata 114.

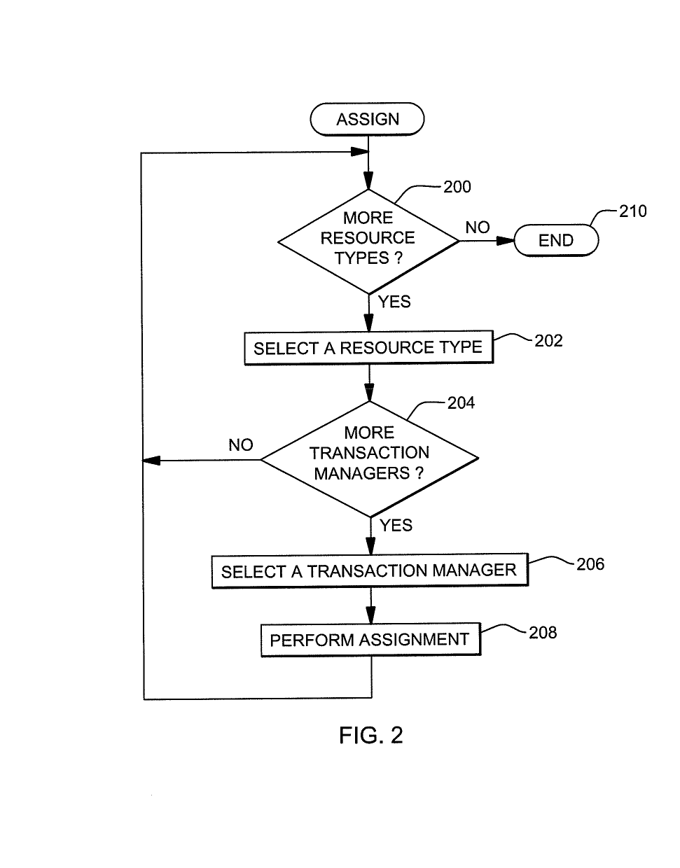

Further, in accordance with an aspect of the present invention, for each transaction manager (or a subset thereof), an indication is provided of the preferred resource types for that transaction manager. One embodiment of the logic used to assign resource types to the various transaction managers is described with reference to FIG. 2.

Referring to FIG. 2, initially, a determination is made as to whether there are more resource types to be assigned to one or more transaction managers, INQUIRY 200. Assuming there are more resource types, a resource type is selected, STEP 202. A further determination is made as to whether there are more transaction managers to be checked to determine if this resource type should be assigned to that transaction manager, INQUIRY 204. Assuming there are more transaction managers, a transaction manager is selected, STEP 206. An assignment is then performed of the resource type to the transaction manager, STEP 208. This assignment includes, for instance, providing an indicator that specifies yes, the resource type is to be assigned to the transaction manager; or no, the resource type is not to be assigned to the transaction manager. In a further example, a weighted system is provided, in which each transaction manager (or other entity) assigns a weight based on its performance for a particular resource type or a combination of resource types. Yet further, in one embodiment, if the transaction manager supports some sort of dynamic or deferred enlistment, this is indicated during the assignment. Deferred or dynamic enlistment is defined to mean that the transaction manager does not need to be told the sum total of the resources which are enlisted in the transaction until commit time. Transaction managers using the presume abort protocol typically fall into this category, since they do not persist any information about the transaction until it is in-doubt.

Subsequent to performing the assignment, STEP 208, or when iteration through the transaction managers is complete, INQUIRY 204, processing continues with INQUIRY 200 “More Resource Types?” If there are no further resource types, then assignment processing is complete, STEP 210.

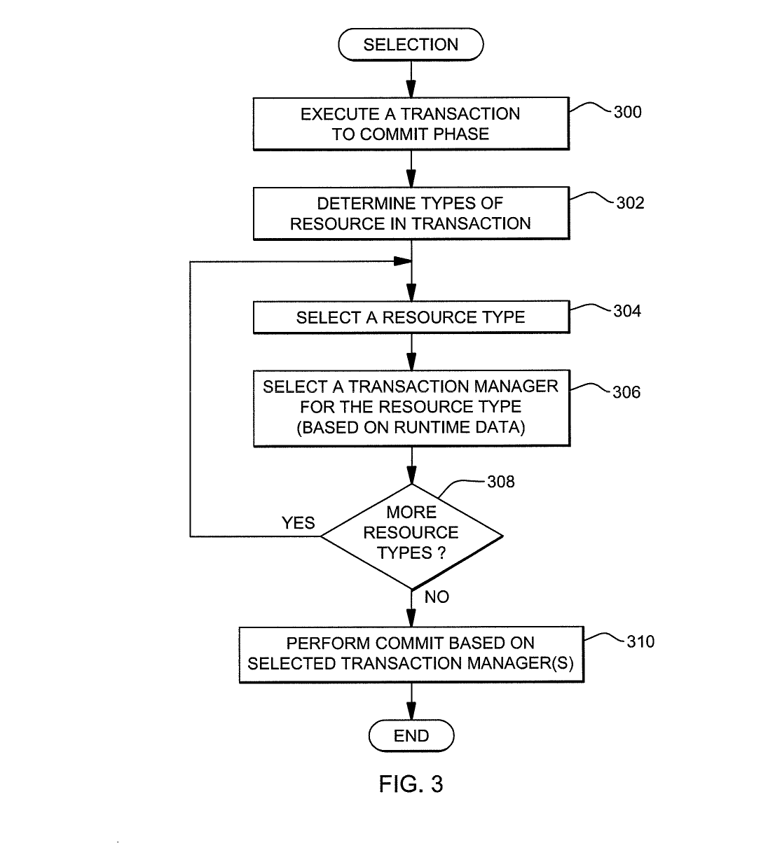

With the assignment of resource types to transaction managers, one or more transaction managers to be used during processing of a particular transaction are selected, in accordance with an aspect of the present invention. One embodiment of the selection process is described with reference to FIG. 3.

In one example, a transaction is executed to the commit phase, STEP 300. At the commit phase or during another phase of transaction processing, the types of resources in the transaction are determined, STEP 302. A resource type is selected, STEP 304, and a transaction manager is selected for that resource type, STEP 306. In one example, the selection is based on runtime data, as further described below.

Thereafter, a determination is made as to whether there are additional resource types, INQUIRY 308. If there are additional resource types, then processing continues with selecting a resource type at STEP 304. However, if there are no more resource types, then processing continues with performing the commit based on the one or more selected transaction managers, STEP 310. The commit is performed, as is known in the art, including performing rollback, if an error occurs.

Further details regarding the selection process are described below with reference to specific examples, which are provided for clarity purposes only. In these examples, if a transaction manager does not support a particular resource type, then it is excluded from the selection process. If there is only one transaction manager that supports the resource type, then that transaction manager is selected. However, assuming there are a number of transaction managers that support the resource type, then one of those transaction managers is selected based on runtime data for those remaining transaction managers.

In the following example, assume there are three resource types (A, B, C), five transaction managers (TM), and the following relationships:
TM #1 supports resource types A and C;
TM #2 supports none of the resource types;
TM #3 supports resource type B;
TM #4 supports resource types A, B, and C; and
TM #5 supports resource types, A, B, and C.
   In this example, TM #2 is automatically removed from consideration. For resource type A, the runtime data for TM #1, TM #4 and TM #5 are compared, and the transaction manager with the most optimal runtime data for that resource type is selected. Similarly, for resource type B, the runtime data of TM #3, TM #4 and TM #5 are compared to find the most optimal transaction manager; and for resource type C, the runtime data of TM #1, TM #4 and TM #5 are compared, again to find the optimal transaction manager for that resource type.

As a further optimization, initially, a determination is made as to whether any of the transaction managers support all three resource types. If so, the runtime data of those transaction managers (e.g., TM #4 and TM #5) are compared and the best is selected. The other transaction managers are ignored. If only one transaction manager supports all the resource types, then that transaction manger is selected, in this example.

In yet a further example, instead of looking at each resource type individually or all of the resource types of the transaction, groupings of resource types may be considered. In this example, the transaction manager with the optimal runtime data for a chosen group of resources is selected. This grouping may provide additional ways to eliminate one or more transaction managers.

In each of the examples, the runtime data that is considered optimal may be based on a number of factors, including, but not limited to, customer or user input. It may be based on a formula that indicates which of the values of the runtime data are most important. It also may be a programmable feature that is adaptable.

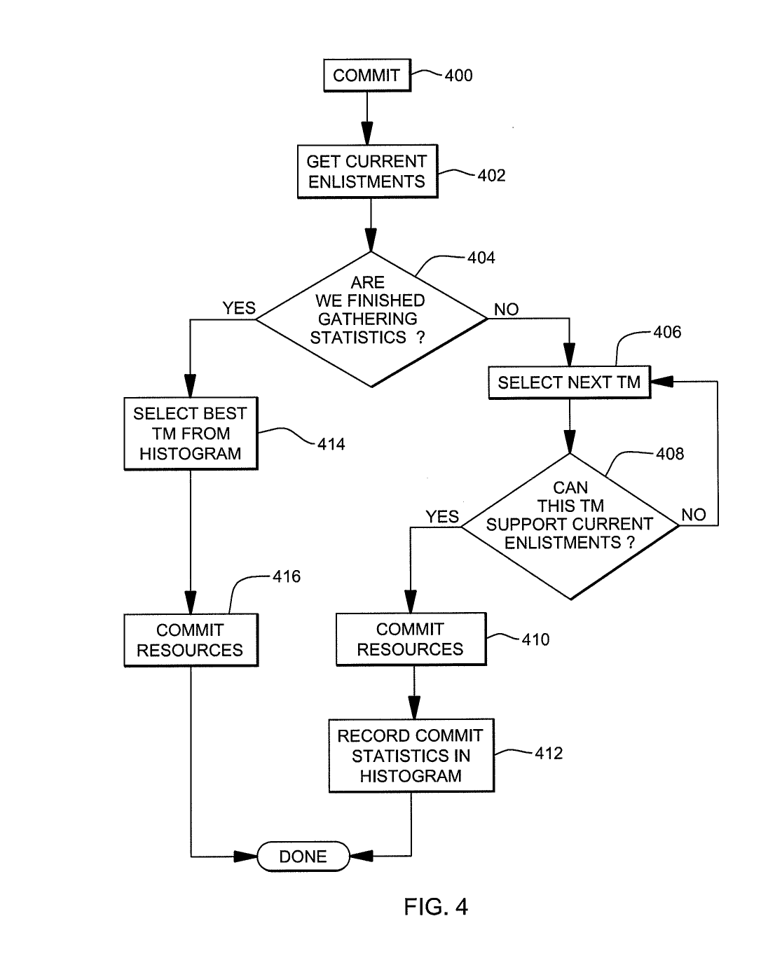

One particular example of selecting one or more transaction managers based on runtime data is described with reference to FIG. 4. In this example, there are an arbitrary number of transaction managers which support an arbitrary number of resource types. It is assumed in this particular example that there are at least two transaction managers that support all of the resource types of the particular transaction.

Referring to FIG. 4, the container commits a transaction for an application or more specifically an application component, STEP 400, and determines the current enlistments (e.g., resources) for the transaction, STEP 402. An oversight transaction manager, which manages the commit processing and is referred to herein as a federated transaction manager, gathers statistics for the transaction managers of the transactional environment, as described below.

Initially, a determination is made as to whether the gathering of statistics is complete, INQUIRY 404. In one example, this is a user defined standard that is programmable. That is, the user can indicate how much data is to be collected. In a further example, a default value may be used. For example, statistics gathering may be considered complete, after runtime statistics for all (or some number) of the transaction managers that can support the enlistments have been collected x times, where x is equal to one or more.

If statistics are still to be gathered, then the next transaction manager for which statistics are to be gathered is selected, STEP 406. A determination is made as to whether this transaction manager can support the current enlistments, INQUIRY 408. If not, then the next transaction manager is selected. If all of the transaction managers have been selected once, then the first transaction manager is re-selected, etc.

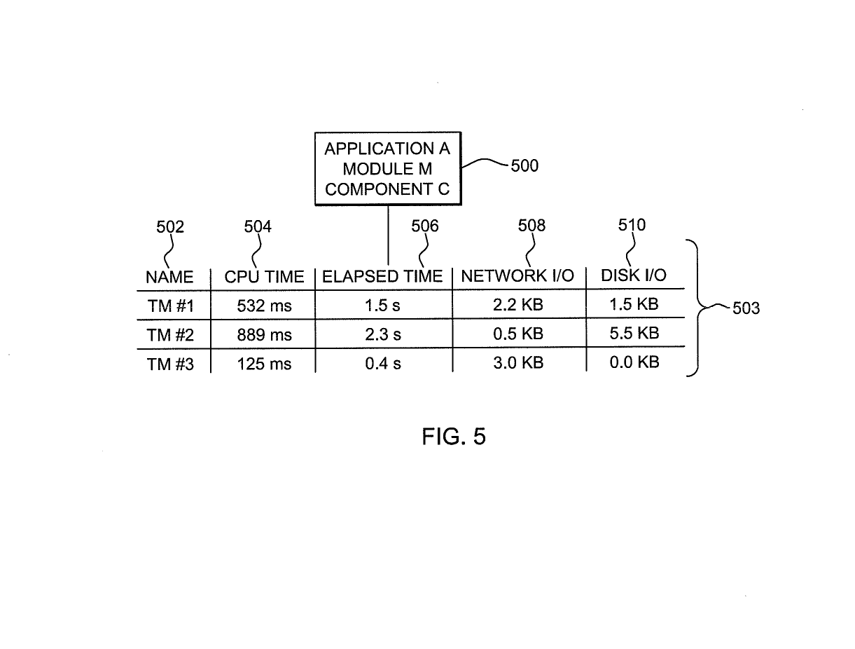

Returning to INQUIRY 408, if this transaction manager can support the current enlistments, then the resources are committed, STEP 410. Additionally, statistics relating to the commit for this transaction manager are recorded in a histogram (or other structure) stored in memory of the processor or other accessible storage media, STEP 412. For instance, if this is the first commit for a given application, then the container creates a histogram to record runtime data of the transaction manager performing the commit. As shown in FIG. 5, in response to a transaction manager 502 committing resources for an application 500, statistics for that transaction manager are included in a histogram 503. In this example, there are three transaction managers that can support the enlistments and have performed commits for the application: TM #1, TM #2 and TM #3. Each transaction manager has statistical values associated therewith, including, for instance, average CPU time per commit 504, average wall clock (elapsed) time per commit 506, average bytes of network I/O per commit 508, and average bytes of disk I/O per commit 510. In other examples, there may be more, fewer or different columns depending on what data is available on the system running the transaction managers.

Returning to FIG. 4, and in particular, INQUIRY 404, if the gathering of statistics is complete, then a transaction manager is selected from the histogram, STEP 414. In one example, the federated transaction manager uses the information in the histogram to determine which transaction manager to select. In this example, the most optimal transaction manager (looking at one or more of the collected statistics, per user discretion, which may be programmed and adapted, or by default) is selected, and that selected transaction manager is then used to commit the resources for any transaction initiated by the application, STEP 416. The selection process is then complete.

In the above example, the histogram for that transaction includes those transaction managers that support all the enlistments. In a further example, histograms are provided for each resource type/transaction manager, or some combination thereof.

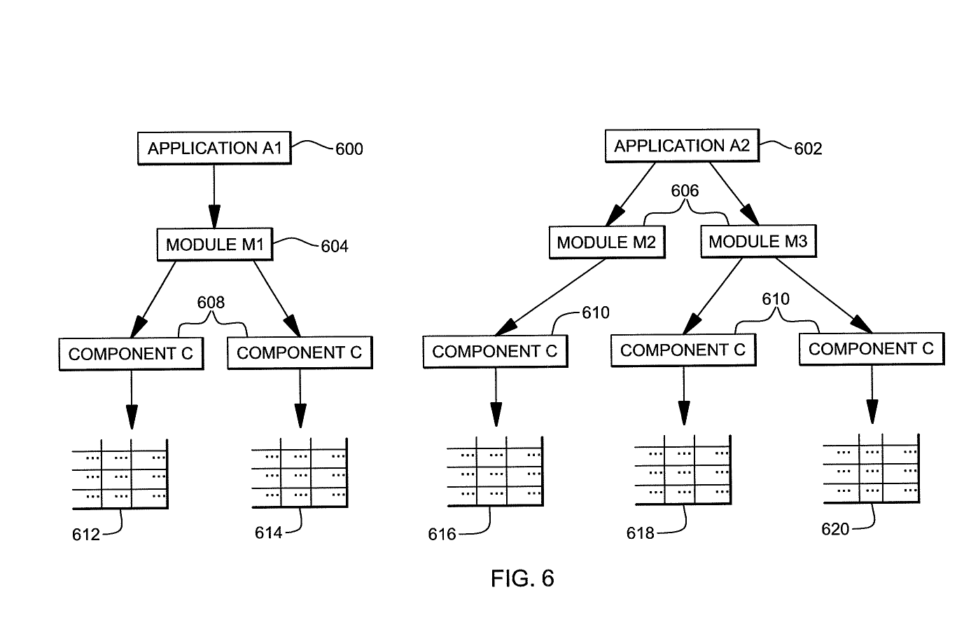

Other examples of histograms are depicted in FIG. 6. In this example, two applications 600, 602, respectively, are separated into modules 604, 606 and components 608, 610, respectively, and each component has its own histogram 612-620, respectively. The histograms are broken out at this level because each application component may have a different set of enlisted resources, which would cause the histograms to have different transaction managers or different use statistics in them. Many other examples are possible.

Described in detail above is an automatic technique for selecting transaction managers based on resource type and runtime data. Allowing the application server to choose the most appropriate transaction manager(s) eliminates the customer's burden of selection. The customer does not need to be concerned with which transaction managers are available or which transaction manager(s) should be selected.

Many resource types may be used in one or more aspects of the present invention, and different transactional environments may have different types of resources. In one particular example, a transaction initiated by an application of the WebSphere® Application Server may use JDBC Type 2 resources that have a proprietary interface with a particular transaction manager (generalized as Type 2 resources) and/or JDBC Type 4 resources which conform to some specification understood in industry (generalized as Type 4 resources). Although examples of resource types are provided herein, these examples are not meant to be limiting in any way. One or more aspects of the present invention are usable with and applicable to many types of resources.

As used herein, “obtaining”, such as obtaining runtime statistics, includes, but is not limited to, collecting, determining, being provided, receiving, having, generating, etc.

In addition to the above, one or more aspects of the present invention can be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider can receive payment from the customer under a subscription and/or fee agreement, as examples. Additionally or alternatively, the service provider can receive payment from the sale of advertising content to one or more third parties.

In one aspect of the present invention, an application can be deployed for performing one or more aspects of the present invention. As one example, the deploying of an application comprises providing computer infrastructure operable to perform one or more aspects of the present invention.

As a further aspect of the present invention, a computing infrastructure can be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer usable medium, in which the computer medium comprises one or more aspects of the present invention. The code in combination with the computer system is capable of performing one or more aspects of the present invention.

One or more aspects of the present invention can be included in an article of manufacture (e.g., one or more computer program products) having, for instance, computer readable media. The media has therein, for instance, computer readable program code means or logic (e.g., instructions, code, commands, etc.) to provide and facilitate the capabilities of the present invention. The article of manufacture can be included as a part of a computer system or sold separately.

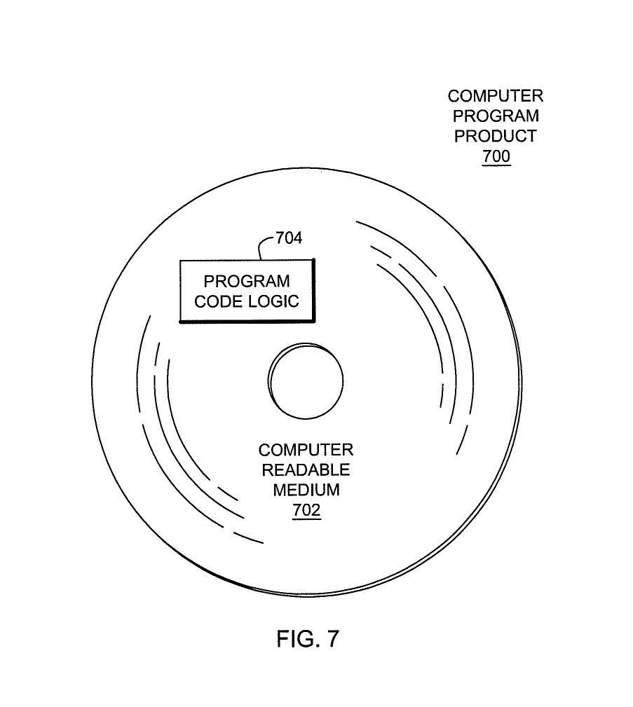

One example of an article of manufacture or a computer program product incorporating one or more aspects of the present invention is described with reference to FIG. 7. A computer program product 700 includes, for instance, one or more computer readable media 702 to store computer readable program code means or logic 704 thereon to provide and facilitate one or more aspects of the present invention. The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Examples of optical disks include compact disk-read only memory (CD-ROM), compact disk-read/write (CD-R/W) and DVD.

A sequence of program instructions or a logical assembly of one or more interrelated modules defined by one or more computer readable program code means or logic direct the performance of one or more aspects of the present invention.

Advantageously, a dynamic and automatic capability for selecting one or more transaction managers for use in completing transactions is provided. Transaction managers are selected based on resource type and runtime data. Such selection enables elimination of those transaction managers not needed for a particular transaction. This reduces the path length of a commit, and improves system performance.

Additional details relating to the selection of transaction managers may be found in U.S. Pat. No. 8,276,141 B2, issued Sep. 25, 2012, “Selection of Transaction Managers Based on Transaction Metadata,” which is hereby incorporated herein by reference in its entirety.

Although various embodiments are described above, these are only examples. Many variations may be made without departing from the spirit of the present invention. For example, selection may be based on metadata other than resource type. Moreover, there may be the same or different resource types than those described herein. Further, transactional environments other than those based on the z/Architecture® may incorporate and use one or more aspects of the present invention. Additionally, distributed environments with heterogeneous servers may benefit from one or more aspects of the present invention. Yet further, other statistics may be collected, including instruction count or any other type of available information. Many other variations also exist.

Further, other types of computing environments can benefit from one or more aspects of the present invention. As an example, an environment may include an emulator (e.g., software or other emulation mechanisms), in which a particular architecture (including, for instance, instruction execution, architected functions, such as address translation, and architected registers) or a subset thereof is emulated (e.g., on a native computer system having a processor and memory). In such an environment, one or more emulation functions of the emulator can implement one or more aspects of the present invention, even though a computer executing the emulator may have a different architecture than the capabilities being emulated. As one example, in emulation mode, the specific instruction or operation being emulated is decoded, and an appropriate emulation function is built to implement the individual instruction or operation.

In an emulation environment, a host computer includes, for instance, a memory to store instructions and data; an instruction fetch unit to fetch instructions from memory and to optionally, provide local buffering for the fetched instruction; an instruction decode unit to receive the instruction fetch unit and to determine the type of instructions that have been fetched; and an instruction execution unit to execute the instructions. Execution may include loading data into a register from memory; storing data back to memory from a register; or performing some type of arithmetic or logical operation, as determined by the decode unit. In one example, each unit is implemented in software. For instance, the operations being performed by the units are implemented as one or more subroutines within emulator software.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The capabilities of one or more aspects of the present invention can be implemented in software, firmware, hardware, or some combination thereof. At least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered a part of the claimed invention.

Although embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating selection of transaction managers for use in transactional processing, said method comprising:
obtaining, by an application server executing on at least one processor of a transactional environment and comprising a plurality of transaction managers, runtime statistics of the plurality of transaction managers of the application server, said runtime statistics of a transaction manager of the plurality of transaction managers including real-time data relating to transaction commit processing performed by the transaction manager for one or more transactions initiated by one or more applications of the application server, wherein the real-time data relating to transaction commit processing include an amount of time taken to perform one or more previous commits of the transaction commit processing or an amount of data to transfer as part of one or more previous commits of the transaction commit processing; and
after executing a transaction, initiated by an application of the application server, to a commit point of the transaction's execution, at which point the transaction is to be committed, performing:
determining one or more types of resources used by the transaction; and
based on the determined one or more types of resources used by the transaction, selecting, by the application server, one or more transaction managers of the plurality of transaction managers of the application server to use in performing commit or rollback processing for the transaction, wherein the selecting comprises identifying transaction managers of the plurality of transaction managers for consideration for use as the one or more transaction managers to use in performing the commit or rollback processing, and eliminating at least one transaction manager of the identified transaction managers from consideration for use as the one or more transaction managers to use in performing the commit or rollback processing, the eliminating of a transaction manager of the at least one transaction manager being based, at least in part, on the obtained runtime statistics.

2. The method of claim 1, wherein the eliminating is further based at least in part on at least one type of resource supported by the transaction manager, and at least in part on the determined one or more types of resources used by the transaction, wherein the eliminating eliminates a transaction manager of the eliminated at least one transaction manager, based on the transaction manager not supporting at least one type of resources of the determined one or more types of resources used by the transaction, wherein, based on the eliminating, one or more remaining transaction managers of the identified transaction managers are identified, and wherein each transaction manager of the one or more remaining transaction managers supports at least one type of resource of the determined one or more types of resources used by the transaction.

3. The method of claim 2, wherein the selecting comprises selecting the one or more transaction managers from the one or more remaining transaction managers based on the obtained runtime statistics.

4. The method of claim 3, wherein the eliminating eliminates transaction managers, of the identified transaction managers, that do not support each type of resource of the determined one or more types of resources used by the transaction, wherein each transaction manager of the one or more remaining transaction managers supports each type of resource of the determined one or more types of resources used by the transaction.

5. The method of claim 1, wherein the runtime statistics are maintained in a histogram accessible by the application server.

6. The method of claim 1, further comprising assigning one or more types of resources to each of the transaction managers of the plurality of transaction managers, wherein the assigning includes assigning to a transaction manager of the plurality of transactions managers a weight based on the transaction manager's performance for a particular type of resource or a combination of types of resources assigned thereto.

7. The method of claim 1, wherein the obtaining runtime statistics for a transaction manager of the plurality of transaction managers comprises performing by the transaction manager the one or more previous commits of the transaction commit processing, and recording real-time data relating to the one or more previous commits.

8. The method of claim 7, wherein the real-time data include at least one of CPU time for the one more previous commits, elapsed time for the one or more previous commits, average bytes of network I/O for the one or more previous commits, and average bytes of disk I/O for the one or more previous commits.

9. The method of claim 1, further comprising completing the transaction by performing the commit or rollback processing for the transaction.
